(19) United States
(12) Patent Application Publication
(10) Pub. No.: US 2026/0249791 A1
(43) Pub. Date: Aug. 27, 2026

(54) AUTOMOTIVE EXTERIOR TUNNEL SILENCER

(71) Applicant: FCA US LLC, Auburn Hills, MI (US)

(72) Inventors: Ander Inarritu Contreras, Auburn Hills, MI (US); Cesar Edgar Estrop Espinosa, Auburn Hills, MI (US); Ricardo Bautista, Auburn Hills, MI (US)

(21) Appl. No.: 19/064,822

(22) Filed: Feb. 27, 2025

(51) Int. Cl. B60R 13/07; B60H 1/00; B60R 13/08; B60L 50/60

(52) U.S. Cl. CPC B60R 13/07; B60H 1/00571; B60R 13/0876; B60L 50/60

(57) ABSTRACT

An external tunnel silencer for a battery electric vehicle has a body having an overall U-shape with a web wall and a first and second sidewall. A channel is formed in the web wall to receive condensation for an HVAC unit. The channel extends to one of the first or second side walls. A channel in the first or second sidewall is positioned to receive liquid from the web wall channel. The sidewall channel acts as a drain to move liquid away from a battery electric vehicle battery.

### FIELD

The present disclosure relates to automotive vehicles and, more particularly, to battery electric vehicles with exterior tunnel silencers.

### BACKGROUND

This section provides background information related to the present disclosure which is not necessarily prior art.

In battery electric vehicles, the vehicle interior air conditioning unit needs to drain condensation water from the condensing of humid air. This usually done through the floor of the vehicle. With the addition of the battery electric vehicle batteries, there is a need to route the water outside of any electrical connector, module and/or battery. The battery electric vehicle batteries may not be able to withstand constant water being poured on top of them. Thus, there is a need for a component that drives water away from critical components and interfaces. Additionally, in case of a thermal runaway event from the battery, any component in contact with the battery electric vehicle battery must meet thermal requirements to prevent any type of smoke or flame damage.

Further, the tunnel isolator is to provide noise reduction, through acoustic insulation in the tunnel, caused by the vehicle transmission. Also, water drained from the interior air conditioning unit is usually drained to the floor of the vehicle through holes, bores, channels and other components. Accordingly, water is drained either on top of the battery or to the front of the dash. Thermal protection of the battery electric vehicle battery will be regulated in the future.

Accordingly, it is desirable to provide a device that eliminates or removes dripping water condensate from the air conditioning unit.

The present disclosure provides a tunnel insulator silencer with at least one channel designed to route the dripping water as soon as the water evacuates the air conditioning unit. The water is diverted to the side of the silencer away from the battery high voltage connectors and the battery electric vehicle battery. Additionally, the tunnel insulator silencer is covered with a film to insulate the tunnel body in white and other components in the event of a thermal runaway event of the battery. The tunnel silencer is able to withstand extreme battery temperature conditions.

### SUMMARY

This section provides a general summary of the disclosure, and is not a comprehensive disclosure of its full scope or all of its features.

According to a first aspect of the disclosure, an external tunnel insulator silencer for a battery electric vehicle comprises a body having an overall U-shape with a web wall and first and second sidewalls. A channel is formed in the web wall to receive condensation from an HVAC unit. The channel extends to one of the first or second side walls. A channel is in the first or second sidewall positioned to receive liquid from the web wall channel. The sidewall channel acts as a drain to move liquid away from a battery electric vehicle battery. The web wall channel is sloped to expedite drainage of the liquid. The first and second sidewalls flare out from the web wall. A flange extends from the body to secure it with the vehicle. A foil covers an interior of the body for insulation purposes in an event of a thermal runway of the battery. The foil is generally aluminum foil to withstand extreme battery heat conditions. The body prohibits liquid from contacting the battery electric vehicle batteries. The web wall channel and sidewall channel are continuous with one another.

According to a second aspect of the disclosure, an electric battery vehicle with an exterior tunnel silencer comprises an electric battery coupled with the vehicle. An exterior tunnel silencer prevents liquid contact with the battery. The exterior tunnel silencer comprises a body having an overall U-shape with a web wall and first and second sidewalls. A channel is formed in the web wall to receive condensation from an HVAC unit. The channel extends to one of the first or second side walls. A channel is in the first or second sidewall positioned to receive liquid from the web wall channel. The sidewall channel acts as a drain to move liquid away from a battery electric vehicle battery. The web wall channel is sloped to expedite drainage of the liquid. The first and second sidewalls flare out from the web wall. A flange extends from the body to secure it with the vehicle. A foil covers an interior of the body for insulation purposes in an event of a thermal runway of the battery. The foil is generally aluminum foil to withstand extreme battery heat conditions. The body prohibits liquid from contacting the battery electric vehicle batteries. The web wall channel and sidewall channel are continuous with one another.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exterior tunnel silencer in accordance with the present disclosure.

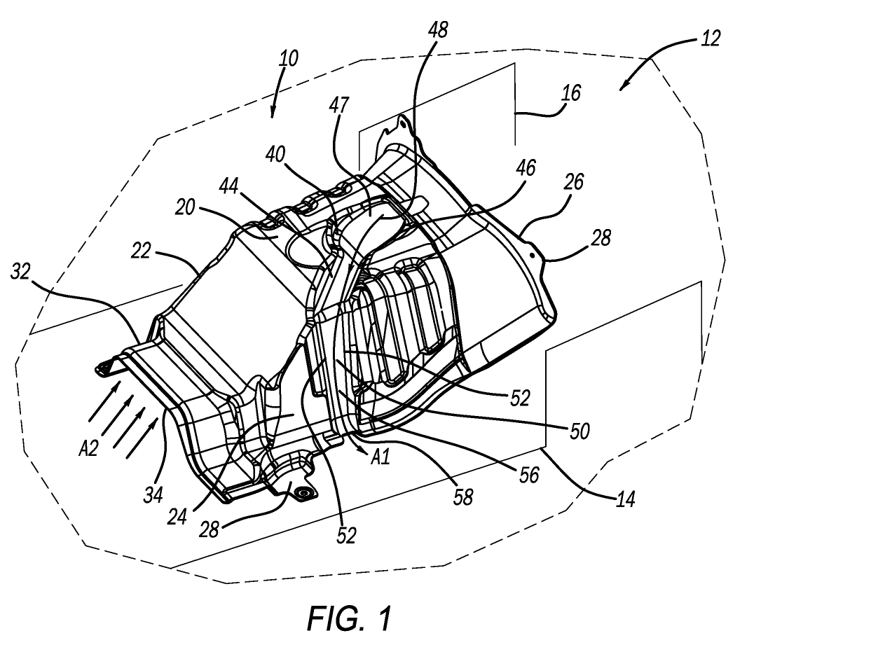

Corresponding reference numerals indicate corresponding parts throughout the several views of the drawings.

### DETAILED DESCRIPTION

Example embodiments will now be described more fully with reference to the accompanying drawings.

Turning to the figure, an exterior tunnel silencer is illustrated and designated with the reference numeral 10. The tunnel silencer 10 is illustrated in a vehicle 12 in phantom. The vehicle 12 includes a battery pack 14 positioned below the exterior tunnel silencer. Additionally, an air conditioning unit 16 is illustrated in the vehicle 12. The air conditioning unit 16 generates liquid through condensing humidity air so that a condensate drips from the air conditioning unit 16. Generally, the exterior tunnel silencer 10 is positioned underneath of the air conditioning unit 16 to remove water or liquid away from the battery pack 14.

The exterior tunnel silencer 10 has an overall U-shape with a web wall 20 with a first sidewall 22 and a second sidewall 24. The sidewalls could be identical. A flange 26 extends from the silencer 10 to secure it to the vehicle. The flange 26 generally has connecting portions 28 that receive fasteners or the like to project through the flange to secure it with the vehicle.

The sidewalls 22, 24 generally flare out from the web wall 20 to provide an angle with respect to the web wall 20. However, the sidewalls 22, 24 could project at right angles from the web wall 20. The silencer 10 also includes a second portion 32 that connects with additional insulating portions of the vehicle. The interior surface of the walls 20-24 may be covered with a film 34. The film 34 may be a foil, such as an aluminum foil, to provide thermal protection to the silencer 10. The aluminum foil 34 insulates the tunnel body in white and other components in the case of a thermal runaway event of the battery pack 14. Thus, the tunnel insulator 10 is able to withstand extreme battery temperature conditions.

The web wall 20 includes a channel 40 with a reservoir portion 42 and a second or stream portion 44. A wall 46 surrounds the reservoir 42 and the stream portion 44 to provide the recessed channel 40. The bottom surface 48 of the reservoir 42 and stream portion 44 is angled or sloped to generate flow of the water or liquid from the reservoir 42 to the stream portion 44 to the sidewall 24. Thus, the water or liquid entering the reservoir 42 is immediately moved or withdrawn from the reservoir 42 towards the stream portion 44 and out due to the mechanical slope of the surface 48 to prevent pooling of the water or liquid in the reservoir 42. The stream portion 44 empties into a channel 50 on the sidewall 24. The channel 50 is defined by sidewalls 52, 54 to provide for exiting of the liquid or water from the stream portion 44. The bottom surface 56 of the channel 50 is generally sloped away from the web wall 20. The end of the channel includes a cutout 58 that provides exiting of the water or liquid away from the battery pack 14. Thus, as the water liquid flows on the exterior tunnel insulator silencer 10, it is moved away from the battery pack 14 and to ambient so that the water or liquid does not interfere with the battery electric vehicle battery pack 14. Thus, the web wall channel 40 is continuous with the sidewall channel 50 to expel the liquid or water which is deposited from the air conditioning unit onto the reservoir portion 42 of the channel 40. The slope of the bottom surface 40 initiates the flow of water from the reservoir 42 to the stream portion 44 and then to the sidewall channel 50. The water then exits through the cutout or outlet 58 to ambient thus directing the water or liquid away from the battery pack 14.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An external tunnel silencer for a battery electric vehicle comprising:
a body having an overall U-shape with a web wall and a first and second sidewall;
a channel formed in the web wall for receiving condensation from an HVAC unit;
the channel extending to one of the first or second sidewalls;
a channel in the first or second sidewall positioned to receive liquid from the web wall channel, the sidewall channel acting as a drain to move liquid away from a battery electric vehicle battery.

2. The external tunnel silencer for a battery electric vehicle of claim 1, wherein the web wall channel is sloped to expedite drainage of the liquid.

3. The external tunnel silencer for a battery electric vehicle of claim 1, wherein the first and second sidewalls flare outward from the web wall.

4. The external tunnel silencer for a battery electric vehicle of claim 1, wherein a flange extends from the body for securing it with the vehicle.

5. The external tunnel silencer for a battery electric vehicle of claim 1, wherein a foil covers an interior of the body for insulation purposes in an event of a thermal runway of the battery.

6. The external tunnel silencer for a battery electric vehicle of claim 5, wherein the foil is aluminum foil for withstanding extreme battery heat conditions.

7. The external tunnel silencer for a battery electric vehicle of claim 1, wherein the body prohibits liquid from contacting the battery electric vehicle batteries.

8. The external tunnel silencer for a battery electric vehicle of claim 1, wherein the web wall channel and sidewall channel are continuous with one another.

9. An electric battery vehicle with an exterior tunnel silencer comprising:
an electric battery coupled with the vehicle;
an exterior tunnel silencer for preventing liquid contact with the battery, the exterior tunnel silencer comprising:
a body having an overall U-shape with a web wall and a first and second sidewall;
a channel formed in the web wall for receiving condensation from an HVAC unit;
the channel extending to one of the first or second sidewalls;
a channel in the first or second sidewall positioned to receive liquid from the web wall channel, the sidewall channel acting as a drain to move liquid away from a battery electric vehicle battery.

10. The electric battery vehicle with an exterior tunnel silencer of claim 9, wherein the web wall channel is sloped to expedite drainage of the liquid.

11. The electric battery vehicle with an exterior tunnel silencer of claim 9, wherein the first and second sidewalls flare outward from the web wall.

12. The electric battery vehicle with an exterior tunnel silencer of claim 9, wherein a flange extends from the body for securing it with the vehicle.

13. The electric battery vehicle with an exterior tunnel silencer of claim 9, wherein a foil covers an interior of the body for insulation purposes in an event of a thermal runway of the battery.

14. The electric battery vehicle with an exterior tunnel silencer of claim 13, wherein the foil is aluminum foil for withstanding extreme battery heat conditions.

15. The electric battery vehicle with an exterior tunnel silencer of claim 9, wherein the body prohibits liquid from contacting the battery electric vehicle batteries.

16. The electric battery vehicle with an exterior tunnel silencer of claim 9, wherein the web wall channel and side wall channel are continuous with one another.
